(19) United States
(12) Patent Application Publication
(10) Pub. No.: US 2023/0123026 A1
(43) Pub. Date: Apr. 20, 2023

(54) TWO-PHASE NEURAL NETWORK ARCHITECTURE FOR USER-SPECIFIC SEARCH RANKING

(71) Applicant: YANDEX EUROPE AG, Luzem (CH)

(72) Inventors: Vsevolod Aleksandrovich SVETLOV, Moscow (RU); Ivan Ilich GUSHCHENKO-CHEVERDA, Ramenskoye (RU)

(21) Appl. No.: 17/734,743

(22) Filed: May 2, 2022

(30) Foreign Application Priority Data
Oct. 18, 2021 (RU) 2021130277

(51) Int. Cl. G06F 16/9535; G06F 40/284; G06N 3/04

(52) U.S. Cl. CPC G06F 16/9535; G06F 40/284; G06N 3/0454

(57) ABSTRACT

A method and system for generating a user-specific search ranking score for a document are disclosed. The method includes receiving a user log including a search history of a user, receiving a query from the user, providing the user log and the query to a first phase of an artificial neural network-based encoder to generate a token-based user representation of the user log and the search query, based, at least in part, on determining a relationship between the user log and the search query. The method further includes receiving a document from a set of search result documents associated with the query, and providing the token-based user representation and the document to a second phase of the artificial neural network-based encoder to generate a ranking score for the document, based, at least in part, on determining a relationship between the token-based user representation and the document.

### FIELD OF TECHNOLOGY

The present technology relates to use of neural network-based ranking of search results, and more specifically, to a two-phase transformer-based neural network architecture for personalized ranking of search results.

### BACKGROUND

Web search is an important problem, with billions of user queries processed daily. Current web search systems typically rank search results according to their relevance to the search query, as well as other criteria. To determine the relevance of search results to a query often involves the use of machine learning algorithms that have been trained using multiple hand-crafted features to estimate various measures of relevance. This relevance determination can be seen as, at least in part, as a language comprehension problem, since the relevance of a document to a search query will have at least some relation to a semantic understanding of both the query and of the search results, even in instances in which the query and results share no common words, or in which the results are images, music, or other non-text results.

Recent developments in neural natural language processing include use of “transformer” machine learning models, as described in Vaswani et al., “Attention Is All You Need,” Advances in neural information processing systems, pages 5998-6008, 2017. A transformer is a deep learning model (i.e. an artificial neural network or other machine learning model having multiple layers) that uses an “attention” mechanism to assign greater significance to some portions of the input than to others. In natural language processing, this attention mechanism is used to provide context to the words in the input, so the same word in different contexts may have different meanings. Transformers are also capable of processing numerous words or natural language tokens in parallel, permitting use of parallelism in training.

Transformers have served as the basis for other advances in natural language processing, including pre-trained systems, which may be pre-trained using a large dataset, and then “refined” for use in specific applications. Examples of such systems include BERT (Bidirectional Encoder Representations from Transformers), as described in Devlin et al., “BERT: Pre-training of Deep Bidirectional Transformers for Language Understanding,” Proceedings of NAACL-HLT 2019, pages 4171-4186, 2019.

The success of transformer-based systems, such as BERT, in natural language processing has led to their use in ranking search results. This introduces new challenges. For example, it is desirable for search systems to provide user-specific ranking of search results, since the most relevant results for one user of a search system may be different than the most relevant results for other users, even if the query is substantially the same. Additionally, the ranked results should be provided as quickly—as close to instantaneous as possible—for smooth search engine operation. It would, therefore, be desirable to provide a transformer-based neural network architecture that is able to quickly provide personalized ranking scores for search results.

### SUMMARY

Various implementations of the disclosed technology provide methods for generating a user-specific search ranking score using a “split” or two-phase neural network architecture based on the BERT transformer-based system. This two-phase neural network architecture provides for computation of ranking scores for search results based on consideration of both user-specific information and results-specific information. The two-phase neural network architecture is able to re-use the output of the first phase in multiple applications of the second phase to generate ranking scores for the results of a search. This reduces the time and resources that are needed to provide personalized search results, thereby improving the performance and efficiency of systems that rank search results. Because such systems may handle tens of millions of active users and thousands of requests per second, improvements in the efficiency of such search ranking systems can also have significant benefits for the size, cost, and energy usage of data centers in which search systems are hosted.

In accordance with one aspect of the present disclosure, the technology is implemented in a computer-implemented method for generating a user-specific search ranking score for a document. The method includes receiving a user log including a search history of a user, receiving a search query from the user, providing the user log and the search query to a first phase of an artificial neural network-based encoder, and generating, using the first phase of the artificial neural network-based encoder, a token-based user representation of the user log and the search query, based, at least in part, on determining a relationship between the user log and the search query. The method further includes receiving a document from a set of search result documents associated with the search query, providing the token-based user representation and the document to a second phase of the artificial neural network-based encoder, and generating, using the second phase of the artificial neural network-based encoder a ranking score for the document, based, at least in part, on determining a relationship between the token-based user representation and the document.

In some implementations, the method further includes providing each document in the set of search result documents and the token-based user representation to the second phase of the artificial neural network-based encoder to generate a set of ranking scores, each ranking score in the set of ranking scores associated with a corresponding document in the set of search result documents. In these implementations, the method also includes using the set of ranking scores to rank the set of search result documents. In some implementations using the set of ranking scores to rank the set of search result documents includes providing the set of ranking scores and the set of search result documents to a machine learning-based model for generating a final ranking.

In some implementations, providing the user log and search query to the first phase of the artificial neural network-based encoder further includes providing tokens representing the user log and search query. In some implementations, providing the user log and search query to the first phase of the artificial neural network-based encoder further includes providing position information associated with the tokens representing the user log and search query.

In some implementations, the first phase of the artificial neural network-based encoder includes an attention mechanism. In some implementations, the first phase of the artificial neural network-based encoder includes a transformer-based encoder. In some implementations, the first phase of the artificial neural network-based encoder includes an encoder based on a bidirectional encoder representation from transformers (BERT) model architecture. In some implementations, the token-based user representation includes a sequence of classifier tokens.

In some implementations, providing the token-based user representation and the document to the second phase of the artificial neural network-based encoder further includes providing tokens representing the document. In some implementations, providing the token-based user representation and the document to the second phase of the artificial neural network-based encoder further includes providing position information associated with the tokens representing the document.

In some implementations, the second phase of the artificial neural network-based encoder includes an attention mechanism. In some implementations, the second phase of the artificial neural network-based encoder includes a transformer-based encoder. In some implementations, the second phase of the artificial neural network-based encoder includes an encoder based on a bidirectional encoder representation from transformers (BERT) model architecture.

In some implementations, a single token-based user representation is used to generate ranking scores for multiple documents by the second phase of the artificial neural network-based encoder.

In accordance with another aspect of the present disclosure, the technology is implemented in a system for generating a user-specific search ranking score for a document. The system includes a processor, a memory coupled to the processor, and an artificial neural network-based encoder controlled by the processor. The memory stores machine-readable instructions that, when executed by the processor, cause the processor to receive a user log including a search history of a user; receive a search query from the user; provide the user log and the search query to a first phase of the artificial neural network-based encoder; use the first phase of the artificial neural network-based encoder to generate a token-based user representation of the user log and the search query, based, at least in part, on determining a relationship between the user log and the search query; receive a document from a set of search result documents associated with the search query; provide the token-based user representation and the document to a second phase of the artificial neural network-based encoder; and use the second phase of the artificial neural network-based encoder to generate a ranking score for the document, based, at least in part, on determining a relationship between the token-based user representation and the document.

In some implementations, the memory further stores machine-readable instructions that, when executed by the processor, cause the processor to: provide each document in the set of search result documents and the token-based user representation to the second phase of the artificial neural network-based encoder to generate a set of ranking scores, each ranking score in the set of ranking scores associated with a corresponding document in the set of search result documents; and use the set of ranking scores to rank the set of search result documents.

In some implementations, the first phase of the artificial neural network-based encoder includes a transformer-based encoder. In some implementations, the token-based user representation includes a sequence of classifier tokens. In some implementations, the second phase of the artificial neural network-based encoder includes a transformer-based encoder.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system for use in some implementations of systems and/or methods of the present technology.

FIG. 2 depicts a block diagram of a machine learning model architecture based on the BERT machine learning model, in accordance with various implementations of the disclosed technology.

FIG. 3 depicts data that may be available to various implementations of the disclosed technology with respect to the user and the results of a search that are to be ranked.

FIG. 4 depicts a block diagram of shows a block diagram of a split BERT-based machine learning model architecture in accordance with various implementations of the disclosed technology.

FIG. 5 depicts a flowchart for a computer-implemented method for generating a user-specific ranking score in accordance with various implementations of the disclosed technology.

FIG. 6 depicts a flowchart for a computer-implemented method of providing ranked search results in accordance with various implementations of the disclosed technology.

### DETAILED DESCRIPTION

Various representative implementations of the disclosed technology will be described more fully hereinafter with reference to the accompanying drawings. The present technology may, however, be implemented in many different forms and should not be construed as limited to the representative implementations set forth herein. In the drawings, the sizes and relative sizes of layers and regions may be exaggerated for clarity. Like numerals refer to like elements throughout.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

It will be understood that, although the terms first, second, third, etc. may be used herein to describe various elements, these elements should not be limited by these terms.

These terms are used to distinguish one element from another. Thus, a first element discussed below could be termed a second element without departing from the teachings of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. By contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The functions of the various elements shown in the figures, including any functional block labeled as a “processor,” may be provided through the use of dedicated hardware as well as hardware capable of executing software. When provided by a processor, the functions may be provided by a single dedicated processor, by a single shared processor, or by a plurality of individual processors, some of which may be shared. In some implementations of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, an application-specific integrated circuit (ASIC), a field-programmable gate array (FPGA), a read-only memory (ROM) for storing software, a random-access memory (RAM), and non-volatile storage. Other hardware, conventional and/or custom, may also be included.

Software modules, or simply modules or units which are implied to be software, may be represented herein as any combination of flowchart elements or other elements indicating the performance of process steps and/or textual description. Such modules may be executed by hardware that is expressly or implicitly shown. Moreover, it should be understood that a module may include, for example, but without limitation, computer program logic, computer program instructions, software, stack, firmware, hardware circuitry, or a combination thereof, which provides the required capabilities.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

The present technology may be implemented as a system, a method, and/or a computer program product. The computer program product may include a computer-readable storage medium (or media) storing computer-readable program instructions that, when executed by a processor, cause the processor to carry out aspects of the disclosed technology.

The computer-readable storage medium may be, for example, an electronic storage device, a magnetic storage device, an optical storage device, an electromagnetic storage device, a semiconductor storage device, or any suitable combination of these. A non-exhaustive list of more specific examples of the computer-readable storage medium includes: a portable computer disk, a hard disk, a random-access memory (RAM), a read-only memory (ROM), a flash memory, an optical disk, a memory stick, a floppy disk, a mechanically or visually encoded medium (e.g., a punch card or bar code), and/or any combination of these. A computer-readable storage medium, as used herein, is to be construed as being a non-transitory computer-readable medium. It is not to be construed as being a transitory signal, such as radio waves or other freely propagating electromagnetic waves, electromagnetic waves propagating through a waveguide or other transmission media (e.g., light pulses passing through a fiber-optic cable), or electrical signals transmitted through a wire.

It will be understood that computer-readable program instructions can be downloaded to respective computing or processing devices from a computer-readable storage medium or to an external computer or external storage device via a network, for example, the Internet, a local area network, a wide area network and/or a wireless network. A network interface in a computing/processing device may receive computer-readable program instructions via the network and forward the computer-readable program instructions for storage in a computer-readable storage medium within the respective computing or processing device.

Computer-readable program instructions for carrying out operations of the present disclosure may be assembler instructions, machine instructions, firmware instructions, configuration data for integrated circuitry, or either source code or object code written in any combination of one or more programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network.

All statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable program instructions. These computer-readable program instructions may be provided to a processor or other programmable data processing apparatus to generate a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowcharts, flow diagrams, state transition diagrams, pseudo-code, and the like.

The computer-readable program instructions may also be loaded onto a computer, other programmable data processing apparatus or other devices to cause a series of operational steps to be performed on the computer, other programmable apparatus or other devices to generate a computer-implemented process, such that the instructions which execute on the computer, other programmable apparatus, or other device implement the functions/acts specified in the flowcharts, flow diagrams, state transition diagrams, pseudo-code, and the like.

In some alternative implementations, the functions noted in flowcharts, flow diagrams, state transition diagrams, pseudo-code, and the like may occur out of the order noted in the figures. For example, two blocks shown in succession in a flowchart may, in fact, be executed substantially concurrently, or the blocks may sometimes be executed in the reverse order, depending upon the functionality involved. It will also be noted that each of the functions noted in the figures, and combinations of such functions can be implemented by special-purpose hardware-based systems that perform the specified functions or acts or by combinations of special-purpose hardware and computer instructions.

With these fundamentals in place, we will now consider some non-limiting examples to illustrate various implementations of aspects of the present disclosure.

### Computer System

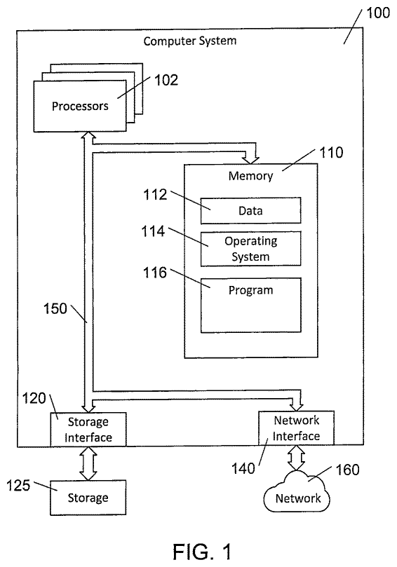

FIG. 1 shows a computer system 100. The computer system 100 may be a multi-user computer, a single user computer, a laptop computer, a tablet computer, a smartphone, an embedded control system, or any other computer system currently known or later developed.

Additionally, it will be recognized that some or all the components of the computer system 100 may be virtualized and/or cloud-based. As shown in FIG. 1, the computer system 100 includes one or more processors 102, a memory 110, a storage interface 120, and a network interface 140. These system components are interconnected via a bus 150, which may include one or more internal and/or external buses (not shown) (e.g. a PCI bus, universal serial bus, IEEE 1394 “Firewire” bus, SCSI bus, Serial-ATA bus, etc.), to which the various hardware components are electronically coupled.

The memory 110, which may be a random-access memory or any other type of memory, may contain data 112, an operating system 114, and a program 116. The data 112 may be any data that serves as input to or output from any program in the computer system 100. The operating system 114 is an operating system such as MICROSOFT WINDOWS or LINUX. The program 116 may be any program or set of programs that include programmed instructions that may be executed by the processor to control actions taken by the computer system 100. For example, the program 116 may be a machine learning training module that trains a machine learning model as described below. The program 116 may also be a system that uses a trained machine learning model to rank search results, as described below.

The storage interface 120 is used to connect storage devices, such as the storage device 125, to the computer system 100. One type of storage device 125 is a solid-state drive, which may use an integrated circuit assembly to store data persistently. A different kind of storage device 125 is a hard drive, such as an electro-mechanical device that uses magnetic storage to store and retrieve digital data. Similarly, the storage device 125 may be an optical drive, a card reader that receives a removable memory card, such as an SD card, or a flash memory device that may be connected to the computer system 100 through, e.g., a universal serial bus (USB).

In some implementations, the computer system 100 may use well-known virtual memory techniques that allow the programs of the computer system 100 to behave as if they have access to a large, contiguous address space instead of access to multiple, smaller storage spaces, such as the memory 110 and the storage device 125. Therefore, while the data 112, the operating system 114, and the programs 116 are shown to reside in the memory 110, those skilled in the art will recognize that these items are not necessarily wholly contained in the memory 110 at the same time.

The processors 102 may include one or more microprocessors and/or other integrated circuits. The processors 102 execute program instructions stored in the memory 110. When the computer system 100 starts up, the processors 102 may initially execute a boot routine and/or the program instructions that make up the operating system 114.

The network interface 140 is used to connect the computer system 100 to other computer systems or networked devices (not shown) via a network 160. The network interface 140 may include a combination of hardware and software that allows communicating on the network 160. In some implementations, the network interface 140 may be a wireless network interface. The software in the network interface 140 may include software that uses one or more network protocols to communicate over the network 160. For example, the network protocols may include TCP/IP (Transmission Control Protocol/Internet Protocol).

It will be understood that the computer system 100 is merely an example and that the disclosed technology may be used with computer systems or other computing devices having different configurations.

### BERT Architecture

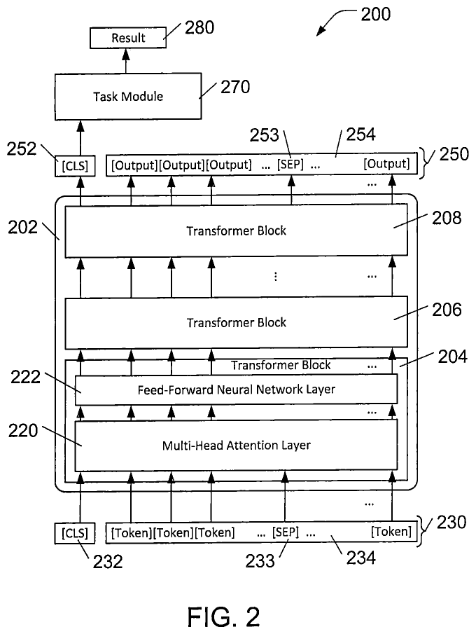

FIG. 2 shows a block diagram of a machine learning model architecture 200 based on the BERT machine learning model, as described, for example, in the Devlin et al. paper referenced above. The machine learning model architecture 200 includes a transformer stack 202 of transformer blocks, including, e.g., transformer blocks 204, 206, and 208.

Each of the transformer blocks 204, 206, and 208 includes a transformer encoder block, as described, e.g., in the Vaswani et al. paper, referenced above. Each of the transformer blocks 204, 206, and 208 includes a multi-head attention layer 220 (shown only in the transformer block 204 here, for purposes of illustration) and a feed-forward neural network layer 222 (also shown only in transformer block 204, for purposes of illustration). The transformer blocks 204, 206, and 208 are generally the same in structure, but (after training) will have different weights. In the multi-head attention layer 220, there are dependencies between the inputs to the transformer block, which may be used, e.g., to provide context information for each input based on each other input to the transformer block. The feed-forward neural network layer 222 generally lacks these dependencies, so the inputs to the feed-forward neural network layer 222 may be processed in parallel. It will be understood that although only three transformer blocks (transformer blocks 204, 206, and 208) are shown in FIG. 2, in actual implementations of the disclosed technology, there may be many more such transformer blocks in the transformer stack 202. For example, some implementations may use 12 transformer blocks in the transformer stack 202.

The inputs 230 to the transformer stack 202 include tokens, such as [CLS] token 232, the [SEP] token 233, and tokens 234. The tokens 234 may, for example represent words or portions of words. The [CLS] token 232 is a “classification” token and is used as a representation for classification for the entire set of tokens. The [SEP] token 233 is used to separate sequences of tokens if there are multiple sequences in the inputs 230. For example, if the inputs 230 include two sentences, the [SEP] token 233 may be used to separate the tokens of the first sentence from the tokens of the second sentence.

Each of the tokens 234, the [CLS] token 232, and the [SEP] token 233 is represented by a vector. In some implementations, these vectors may each be, e.g., 768 floating point values in length. It will be understood that a variety of compression techniques may be used to effectively reduce the sizes of the tokens. In various implementations, there may be a fixed number of tokens that are used as inputs 230 to the transformer stack 202. For example, in some implementations, 1024 tokens (aside from the [CLS] token 232) may be used, while in other implementations, the transformer stack 202 may be configured to take 512 tokens (aside from the [CLS] token 232). Inputs 230 that are shorter than this fixed number of tokens 234 may be extended to the fixed length by adding padding tokens.

The tokens in the inputs 230 may embed several types of information, including token information (not shown), position information (not shown), and segment information (not shown). The token information encodes input text using a pre-built vocabulary of tokens that are suited to natural language text. In some implementations, this may be done by using a known WordPiece byte-pair encoding scheme with a sufficiently large vocabulary size. For example, in some implementations, the vocabulary size may be approximately 30,000 tokens, representing the most common words and subwords found in, e.g., the English language. In some implementations, a larger vocabulary size, such as 120,000 tokens, may be used to provide tokens for specialized vocabulary or to represent information other than words and/or subwords in a natural language. The tokens are typically represented numerically. A WordPiece byte-pair encoding scheme that may be used in some implementations to build the token vocabulary is described, for example, in Rico Sennrich et al., “Neural Machine Translation of Rare Words with Subword Units”, Proceedings of the 54th Annual Meeting of the Association for Computational Linguistics (Volume 1: Long Papers), pages 1715-1725, 2016.

The position information encodes the position of the token within the sequence of inputs 230. For example, the [CLS] token 232 is typically found at position 0, with the tokens 234 occupying positions 1, 2, 3, and so on. Encoding position information in the inputs 230 permits the model to take the positions of words into account.

The sequence information encodes the sequence with which a token is associated into the token. For example, if the inputs 230 include two sentences, each of which is treated as a “sequence,” then the sequence information encodes information on which of the sentences the token is associated with into the token.

The outputs 250 of the transformer stack 202 include a [CLS] output 252, and vector outputs 254, including a vector output for each of the tokens 234 in the inputs 230 to the transformer stack 202. If the inputs 230 included a [SEP] token 233, then the outputs 250 may also include a [SEP] output 253.

The outputs 250 may be sent to a task module 270. In some implementations, as is shown in FIG. 2, the task module 270 uses only the [CLS] output 252, which serves as a representation of the entire set of outputs 254. This is most useful when the task module 270 is being used for a classification task, or to output a label or value that characterizes the entire input. In some implementations (not shown in FIG. 2) all or some of the outputs 254, and possibly the [CLS] output 252 may serve as inputs to the task module 270. This is most useful when the task module 270 is being used to generate labels or values for the individual input tokens 234, such as for prediction of a masked or missing token or for named entity recognition. In some implementations, the task module 270 may include a feed-forward neural network (not shown) that generates a task-specific result 280, such as a relevance score. Other models could also be used in the task module 270. For example, the task module 270 may itself be a transformer or other form of neural network.

In some implementations, training the BERT model includes two phases—pre-training and fine-tuning. Pre-training is used to train the transformer stack 202 to detect general linguistic patterns in the text using a large unlabeled training corpus. In some implementations, this unlabeled training corpus may be, e.g., the contents of the WIKIPEDIA free encyclopedia, or the text of thousands of books. During fine-tuning, the pre-trained model is used as the basis for training both the task module 270 and the transformer stack 202 to perform specific tasks, such as ranking search results or classifying text, using a much smaller labeled training data set.

The BERT model is pre-trained using two unsupervised learning objectives. The first of these is a masked language modeling (MLM) objective. To pretrain with the MLM objective, one or more tokens in the input to the machine learning model are masked by replacing them with a special [MASK] token (not shown). The machine learning model is trained to predict the probabilities of a masked token corresponding to tokens in the vocabulary of tokens. This is done based on the outputs 250 (each of which is a vector) of the last layer of the transformer stack 202 that correspond to the masked tokens. Since we know the actual masked tokens (i.e., the “ground truth”), a cross-entropy loss representing a measure of the distance of the predicted probabilities from the actual masked tokens (referred to herein as “MLM loss”) is calculated and used to adjust the weights in the machine learning model to reduce the loss.

In some implementations, a predefined portion of the input tokens 234, such as 15%, will be randomly selected for masking. Of these randomly selected tokens, a predefined portion, e.g., 80% are replaced with a [MASK] token, and a second predefined portion, e.g., 10% are replaced with random tokens selected from the vocabulary. The remaining selected tokens (10% in the example discussed here) remain unchanged.

The second of the unsupervised learning objectives used in pre-training the BERT model is a next sentence prediction (NSP) objective. To pretrain the model using the NSP objective, pairs of sentences (generally separated by a [SEP] token) are used as the inputs 230. While the model is being pre-trained, half of the inputs are a pair of sentences in which the second sentence follows the first sentence in the training corpus. In the other half of the inputs, the second sentence is chosen randomly from the training corpus, so it will have no relation to the first sentence. The model is trained to determine a probability that the second sentence follows the first sentence. This typically involves using a classification layer (not shown) that takes the [CLS] output 252 as input, and determines a probability (e.g., using softmax) that the second sentence follows the first. Because the system knows the ground truth for any given pair of sentences, a loss (the “NSP loss”) can be calculated and used to adjust the weights in the machine learning model to reduce the loss.

Fine-tuning a BERT-based model to perform a specific task generally involves using the pre-trained transformer stack 202 and adding on a task module 270 for the specific task. For most tasks, the task module 270 may be much smaller than the transformer stack 202, and may be trained using a much smaller labeled training data set.

In some implementations, pre-training the transformer stack 202 may be a relatively time-consuming process, that may take, e.g., several days. Fine-tuning may be much faster. In some implementations, pre-training may be done only once, and the result may then be reused in many applications, by replacing the task module 270 and fine-tuning for the application.

It will be understood that the model architecture described with reference to FIG. 2 has been simplified for ease of understanding. For example, in an actual implementation of the machine learning model architecture 200, each of the transformer blocks 204, 206, and 208 may also include layer normalization operations, the task module 270 may include a softmax normalization function, and so on. One of ordinary skill in the art would understand that these operations are commonly used in neural networks and deep learning models such the machine learning model architecture 200.

### Personalized Search Ranking

In accordance with various implementations of the disclosed technology, a BERT-based machine learning model architecture, such as is described with reference to FIG. 2 may be used to provide ranking scores to the results of a search. These results may be personalized for a user according to information available to the ranking system about the user.

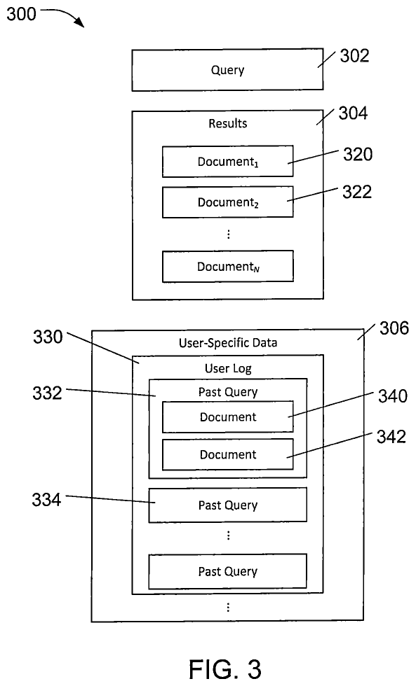

FIG. 3 shows data 300 that may be available to various implementations of the disclosed technology with respect to the user and the results of a search that are to be ranked.

The data include a query 302, which provides the query of the current search, for which results are to be ranked. The data further include a set of results 304 that are to be ranked by the system. The set of results 304 will generally include numerous documents, such as documents 320 and 322, that are results produced by a search engine (not shown) based on the query 302.

The data also includes user-specific data 306. In some implementations, the user-specific data 306 may include user log data 330, which includes the user's past queries, such as past queries 332 and 334. In some implementations, information on the results of a past query, may include the results of the past query and/or the documents from the results that were viewed by the user. For example, for the past query 332, the user log data 330 includes references to documents 340 and 342, which were viewed by the user from the results of the past query 332. It will be understood the contents of the user-specific data 306 may vary between implementations, but will generally include logged data, such as user log data 330.

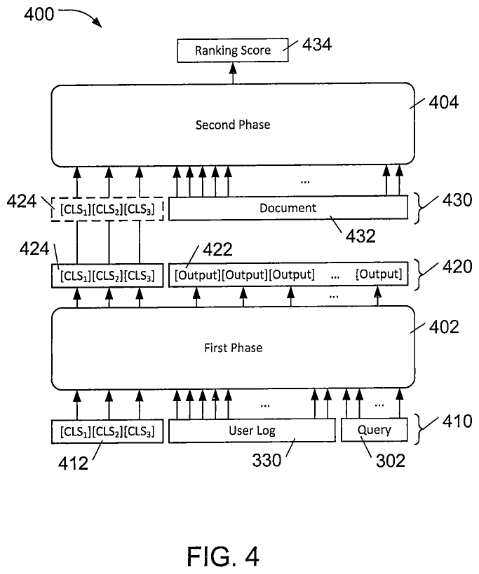

FIG. 4 shows a block diagram of a split BERT-based machine learning model architecture 400, according to some implementations of the disclosed technology. The split BERT-based machine learning model architecture 400 includes a first phase 402 of a neural network-based encoder and a second phase 404 of the neural network-based encoder. The first phase 402 includes a transformer stack (not shown) of a pre-trained BERT-based model architecture such as is described above with reference to FIG. 2, that uses a sequence of classifier ([CLS]) tokens, rather than a single classifier token (three such tokens are shown in FIG. 2, but other numbers of classifier tokens may be used). The inputs 410 of the first phase 402 include user log data 330, the query 302, and initial values of a sequence of classifier tokens 412. The user log data 330 and the query 302 both provide user-specific information. For the user log data 330, this will generally include past queries made by the user, while the query 302 is a current query made by the user. As discussed above with reference to FIG. 2, in some implementations, the inputs 410 may be tokenized, and may also include position and sequence information (not shown).

Based on the inputs 410, the first phase 402 generates outputs 420, which include output tokens 422 and a sequence of output classifier tokens 424. The output classifier tokens 424 encode information about relationships (at least the context-based linguistic relationships that are captured by BERT) within and between the user log data 330 and the query 302. Because of the bidirectionality of the BERT-based machine learning model, the sequence of output classifier tokens 424 encode information related to all the inputs 410 and relationships within the inputs 410.

The use of a sequence of classifier tokens accommodates encoding an increased amount of information regarding the user log data 330, the query 302 within the sequence of output classifier tokens 424. The number of output classifier tokens in the sequence of output classifier tokens 424 may vary between implementations and may be seen as a design choice that balances speed against quality of the personalized rankings.

The sequence of output classifier tokens 424 can be seen as a compact representation of user-specific information in the user log data 330 as it relates to the query 302. Because this includes user-specific information that may be used to generate personalized ranking scores of the search results of the query 302 for the user, the sequence of output classifier tokens 424 effectively provides a token-based user representation that can be computed only once per search and may then be reused with each of the documents in the set of results 304.

The first phase 402 of the neural network-based encoder may be pre-trained using the MLM objective and the NSP objective as described above, using multiple classifier tokens, instead of a single classifier token. As with BERT, this unsupervised learning may use a large training corpus of text, preferably similar to the kinds of text that are found in search queries and user search logs. Due to the relatively slow convergence of transformers being trained on the MLM and NSP objectives, it is expected that this pre-training may take a relatively long period of time, perhaps as much as several days. This pre-training may be performed off-line.

The second phase 404 of the neural network-based encoder includes a pre-trained BERT-based model architecture such as is described above with reference to FIG. 2. The inputs 430 of the second phase 404 include the sequence of output classifier tokens 424 from the first phase 402, which represent the user log data 330 and the query 302. The inputs 430 also include a document 432 from the set of results 304 (not shown in FIG. 4) of a search on the query 302. The document 432 may be tokenized, as discussed above, and the tokens may include information on position and sequence.

The second phase 404 includes a task module (not shown) that has been fine-tuned to generate a ranking score 434 for the document 432, that provides a personalized ranking that is based on the document 432, and on the token-based user representation information that is encoded in the sequence of output classifier tokens 424 from the first phase 402.

Like the first phase 402, the second phase 404 of the neural network-based encoder is pre-trained using the MLM and NSP objectives, similar to pre-training BERT. After pre-training, which may be performed off-line, the second phase 404 undergoes fine-tuning using a pre-labeled training set of document scores. In some implementations, the fine-tuning trains the task module (not shown) associated with the second phase 404. In some implementations, the fine-tuning trains the task module (not shown), as well as the second phase 404, and (in some implementations) the first phase 402 of the neural network-based encoder.

During the real-time handling of a search query, the model receives a set of results from a search engine (not shown) that includes N documents. The N documents in the set of search results are to be ranked for the user, using the user's prior search history and query to generate personalized rankings. The first phase 402 of the neural network-based encoder generates one sequence of output classifier tokens 424. The second phase 404 is then used to generate N ranking scores—one ranking score for each of the N documents in the set of search results. Based on the set of N ranking scores, a separate model (not shown), may generate a final ranked set of N documents.

One advantages of the described split BERT-based machine learning model architecture 400 is that numerous iterations of the second phase 404 of the neural network-based encoder may re-use the sequence of output classifier tokens 424 generated by the first phase 402. This results in improved performance in generating personalized rankings of search results.

It will be understood that although the first phase 402 and the second phase 404 of the neural network-based encoder are described as being BERT-based, in some implementations, other transformer-based or neural network-based model architectures could be used. For example, in some implementations, the two phases of the neural network-based encoder may have transformer stacks that resemble a part of a BERT model architecture, or that use a different number of transformer blocks than is generally used in BERT. Additionally, there may be many other modifications or variations. For example, as discussed above, the number of classifier tokens in the sequence of output classifier tokens may be different in various implementations.

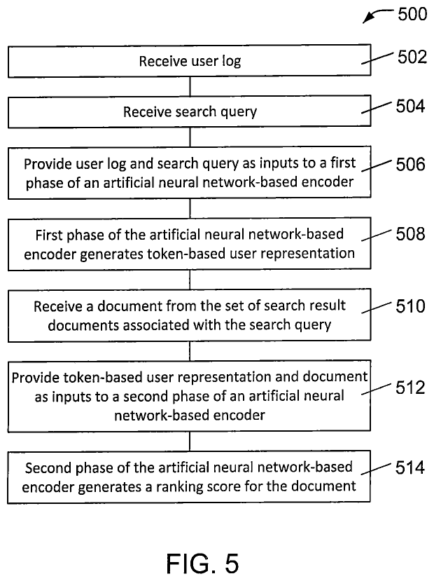

FIG. 5 shows a flowchart 500 for a computer-implemented method for generating a user-specific ranking score according to various implementations of the disclosed technology.

At block 502, a user log that includes a search history of a user is received by a processor. Such logs or records of past searches for a user are typically kept by online search engines or services. For purposes of ranking search results the search engine that generated the results should be able to provide this information to a search ranking process.

At block 504, the processor receives a search query from the user. The search query defines the search that is performed by a search engine or service and may be sent to the processor through the search engine or service that generated search results responsive to the query that are to be ranked.

At block 506, the processor provides the user log and the search query as inputs to a first phase of an artificial neural network-based encoder. As has been discussed above, these inputs may be tokenized, and the tokens may also encode information on the position and sequence of each of the tokens. In some implementations, the first phase of the artificial neural network-based encoder may be a transformer-based model, that includes, e.g., numerous transformer blocks, each of which may include an attention mechanism, such as a multi-head attention layer. In some implementations, the first phase of the artificial neural network-based encoder may be based on the BERT model architecture.

At block 508, the first phase of the artificial neural network-based encoder generates a token-based user representation or encoding of the user log and the search query. In some implementations, this token-based user representation may take the form of a sequence of classification tokens, such as the [CLS] tokens used in BERT. As discussed above, this sequence of classification tokens includes information on the user log and the search query, and also encodes information on relationships within and between the user log and the search query.

At block 510, the processor receives a document from the set of search result documents associated with the search query. The set of search result documents are the documents that have been found by a search engine or service that are responsive to the query. The set if search result documents may be sent by the search engine or service, so that the documents can be ranked.

At block 512, the token-based user representation generated by the first phase of the artificial neural network-based encoder and the document from the set of search result documents are provided to a second phase of the artificial neural network-based encoder. As with the first phase, the second phase of the artificial neural network-based encoder may be a transformer-based model, that includes, e.g., numerous transformer blocks, each of which may include an attention mechanism, such as a multi-head attention layer. In some implementations, the second phase of the artificial neural network-based encoder may be based on the BERT model architecture. In some implementations, the second phase may include a task module that has been fine-tuned to determine a ranking score.

At block 514, the second phase of the artificial neural network-based encoder generates a ranking score for the document. The ranking score is a user-specific ranking score that is based on the user-specific information that is encoded in the token-based user representation and on the document from the set of search result documents, as well as relationships within and between these inputs to the second phase.

It will be understood that blocks 502-508, which are directed to the operation of the first phase of the artificial neural network-based encoder, need be performed only once for each search, since the token-based user representation will be the same for all the documents in the set of search result documents. Blocks 510-514, which are directed to the operation of the second phase of the artificial neural network-based encoder are performed for each of the documents in the set of search result documents, to generate a ranking score for each of the documents.

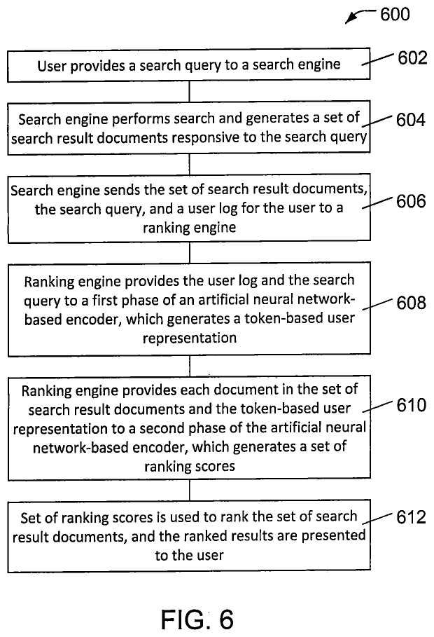

FIG. 6 shows a flowchart 600 for a method of providing ranked search results using the method described above with reference to FIG. 5.

At block 602, a user provides a search query to a search engine or service. At block 604, the search engine performs the requested search, and generates a set of search result documents that are responsive to the search query.

At block 606, the search engine sends the set of search result documents, the search query, and a user log including the user's search history to a ranking engine. At block 608, the ranking engine provides the user log and the search query to a first phase of an artificial neural network-based encoder, as discussed above with reference to blocks 502-508 of FIG. 5. The first phase of the artificial neural network-based encoder generates a token-based user representation.

At block 610, the ranking engine provides each document in the set of search result documents, as well as the token-based user representation, to a second phase of the artificial neural network-based encoder, as discussed above with reference to blocks 510-514 of FIG. 5. The second phase of the artificial neural network-based encoder generates a set of ranking scores, in which each ranking score is associated with a corresponding document in the set of search result documents.

At block 612, the set of ranking scores is used to rank the set of search result documents, and the ranked search results are presented to the user. Using the set of ranking scores to rank the documents may be done in some implementations by sorting the set of search result documents according to their ranking scores. In some implementations, the process of ranking the documents may be more complex, and may involve, e.g., a machine learning-based model that ranks the documents based on the set of ranking scores and the set of search result documents.

It will be understood that, although the embodiments presented herein have been described with reference to specific features and structures, various modifications and combinations may be made without departing from such disclosures. For example, various optimizations that have been applied to neural networks, including transformers and/or BERT may be similarly applied with the disclosed technology. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A computer-implemented method for generating a user-specific search ranking score for a document, the method comprising:
receiving a user log including a search history of a user;
receiving a search query from the user;
providing the user log and the search query to a first phase of an artificial neural network-based encoder;
generating, using the first phase of the artificial neural network-based encoder, a token-based user representation of the user log and the search query, based, at least in part, on determining a relationship between the user log and the search query;
receiving a document from a set of search result documents associated with the search query;
providing the token-based user representation and the document to a second phase of the artificial neural network-based encoder; and
generating, using the second phase of the artificial neural network-based encoder a ranking score for the document, based, at least in part, on determining a relationship between the token-based user representation and the document.

2. The computer-implemented method of claim 1, further comprising:
providing each document in the set of search result documents and the token-based user representation to the second phase of the artificial neural network-based encoder to generate a set of ranking scores, each ranking score in the set of ranking scores associated with a corresponding document in the set of search result documents; and
using the set of ranking scores to rank the set of search result documents.

3. The computer-implemented method of claim 2, wherein using the set of ranking scores to rank the set of search result documents comprises providing the set of ranking scores and the set of search result documents to a machine learning-based model for generating a final ranking.

4. The computer-implemented method of claim 1, wherein providing the user log and search query to the first phase of the artificial neural network-based encoder further comprises providing tokens representing the user log and search query.

5. The computer-implemented method of claim 4, wherein providing the user log and search query to the first phase of the artificial neural network-based encoder further comprises providing position information associated with the tokens representing the user log and search query.

6. The computer-implemented method of claim 1, wherein the first phase of the artificial neural network-based encoder comprises an attention mechanism.

7. The computer-implemented method of claim 1, wherein the first phase of the artificial neural network-based encoder comprises a transformer-based encoder.

8. The computer-implemented method of claim 7, wherein the first phase of the artificial neural network-based encoder comprises an encoder based on a bidirectional encoder representation from transformers (BERT) model architecture.

9. The computer-implemented method of claim 7, wherein the token-based user representation comprises a sequence of classifier tokens.

10. The computer-implemented method of claim 1, wherein providing the token-based user representation and the document to the second phase of the artificial neural network-based encoder further comprises providing tokens representing the document.

11. The computer-implemented method of claim 10, wherein providing the token-based user representation and the document to the second phase of the artificial neural network-based encoder further comprises providing position information associated with the tokens representing the document.

12. The computer-implemented method of claim 1, wherein the second phase of the artificial neural network-based encoder comprises an attention mechanism.

13. The computer-implemented method of claim 1, wherein the second phase of the artificial neural network-based encoder comprises a transformer-based encoder.

14. The computer-implemented method of claim 13, wherein the second phase of the artificial neural network-based encoder comprises an encoder based on a bidirectional encoder representation from transformers (BERT) model architecture.

15. The computer-implemented method of claim 1, wherein a single token-based user representation is used to generate ranking scores for multiple documents by the second phase of the artificial neural network-based encoder.

16. A ranking system for generating a user-specific search ranking score for a document, the system comprising:
a processor;
a memory coupled to the processor; and
an artificial neural network-based encoder controlled by the processor;
wherein the memory stores machine-readable instructions that, when executed by the processor, cause the processor to:
receive a user log including a search history of a user;
receive a search query from the user;
provide the user log and the search query to a first phase of the artificial neural network-based encoder;
use the first phase of the artificial neural network-based encoder to generate a token-based user representation of the user log and the search query, based, at least in part, on determining a relationship between the user log and the search query;
receive a document from a set of search result documents associated with the search query;
provide the token-based user representation and the document to a second phase of the artificial neural network-based encoder; and
use the second phase of the artificial neural network-based encoder to generate a ranking score for the document, based, at least in part, on determining a relationship between the token-based user representation and the document.

17. The ranking system of claim 16, wherein the memory further stores machine-readable instructions that, when executed by the processor, cause the processor to:
provide each document in the set of search result documents and the token-based user representation to the second phase of the artificial neural network-based encoder to generate a set of ranking scores, each ranking score in the set of ranking scores associated with a corresponding document in the set of search result documents; and
use the set of ranking scores to rank the set of search result documents.

18. The ranking system of claim 16, wherein the first phase of the artificial neural network-based encoder comprises a transformer-based encoder.

19. The ranking system of claim 18, wherein the token-based user representation comprises a sequence of classifier tokens.

20. The ranking system of claim 16, wherein the second phase of the artificial neural network-based encoder comprises a transformer-based encoder.
